(19) United States
(12) Patent Application Publication
(10) Pub. No.: US 2017/0219987 A1
(43) Pub. Date: Aug. 3, 2017

(54) CLEANING BLADE

(71) Applicant: SUMITOMO RIKO COMPANY LIMITED, Komaki-shi (JP)

(72) Inventors: Naoki Nakamura, Komaki-shi (JP); Kazushi Yamaguchi, Komaki-shi (JP); Satoshi Suzuki, Komaki-shi (JP); Yasunori Nimura, Komaki-shi (JP)

(73) Assignee: SUMITOMO RIKO COMPANY LIMITED, Komaki-shi (JP)

(21) Appl. No.: 15/485,526

(22) Filed: Apr. 12, 2017

Related U.S. Application Data
(63) Continuation of application No. PCT/JP2015/077646, filed on Sep. 30, 2015.

(30) Foreign Application Priority Data
Dec. 22, 2014 (JP) 2014-258200

(51) Int. Cl. G03G 21/00

(52) U.S. Cl. CPC G03G 21/0029; G03G 21/0017

(57) ABSTRACT

The present disclosure provides a cleaning blade (2) that prevents toner from slipping through the cleaning blade in a long time use. The cleaning blade (2) is used to remove residual toner remaining on a surface of a counterpart member (1) in an electrophotographic image forming device by sliding contact with the counterpart member (1). The cleaning blade (2) includes a support (3) including a plate-shaped portion (31); and a blade part (4) made of polyurethane, and joined to the plate-shaped portion (31) in integral forming. The blade part (4) includes a plate-shaped blade body portion (41) that is joined to a plate surface of the plate-shaped portion (31), and a reinforcing portion (42) that extends from a surface of the blade body portion (41) and is joined to a front end face of the plate-shaped portion (31). The reinforcing portion (42) has a curved surface (421) that curves inward.

### CROSS-REFERENCE

This application is a Continuation of International Application No. PCT/JP2015/077646 filed Sep. 30, 2015, which claims priority to Japanese Patent Application No. 2014-258200 filed on Dec. 22, 2014. The entire contents of which are incorporated herein by reference.

### TECHNICAL FIELD

The present disclosure relates to a cleaning blade, and more particularly to a cleaning blade for use in an electrophotographic image forming device.

### BACKGROUND ART

An electrophotographic image forming device employs a cleaning blade to clean, for instance, the surfaces of an image bearing member such as a photoreceptor and an intermediate transfer belt. The cleaning blade has a blade part, a front edge portion of which is pressed onto the surfaces of the image bearing member and the intermediate transfer belt as counterpart members. A residual toner that remains on the surface of the counterpart members is scraped off and removed by sliding contact of the edge portion with the counterpart member.

One example of conventional cleaning blades, which is widely known, includes a metallic support that has a plate-shaped portion, and a blade part that is formed of plate-shaped polyurethane and is bonded onto one surface of the plate-shaped portion on the front end side thereof through a primer and a hot melt adhesive.

In addition, a cleaning blade proposed in Patent Document 1 is provided with reinforcing elastic bodies joined to both of the plate surface of the blade part, and the front end face of the supporting plate. The reinforcing elastic bodies in this document have a triangular shape or trapezoidal shape in cross section.

### PRIOR ART DOCUMENT

### Patent Document

Patent Document 1: JP-A-2005-326459

### SUMMARY OF THE INVENTION

In recent years, higher-speed operation of an image forming device has been developed. The higher-speed operation of the image forming device requires an increase in the rotational speeds of an image bearing member and an intermediate transfer belt. Thus, if a conventional cleaning blade as widely known is used under the condition that a contact pressure to press the surface of the counterpart member is set at the same level as conventional, slip-through of a toner is caused by shortage of the contact pressure. Particularly in recent years, due to a demand for a high-quality image, a toner having a spherical shape with a small diameter has been employed. Under such a background, even a slight clearance between the surface of the counterpart member and the edge portion of the blade portion may cause the toner to slip therethrough.

One solution to cope with the above described problem is to increase the contact pressure of the blade part by changing the position of the cleaning blade to be closer to the counterpart member than in a conventional cleaning blade. This solution, however, increases a frictional force between the blade part and the counterpart member, which causes curling up of the front end of the blade part. If cleaning is continuously performed under such a condition that the blade part is curled up, the side face of the blade part suffers abrasion in some places. Progressed abrasion, in some cases, may chip the front end of the blade part. As mentioned above, this solution cannot address a recent requirement for enhancement of durability of the image forming device. Therefore, it becomes necessary for a cleaning blade to increase the contact pressure of the blade part without changing the position of the cleaning blade to be closer to the counterpart member.

Patent Document 1 proposes a method for simply increasing the contact pressure of the blade part. However, because the cleaning blade is provided with reinforcing elastic bodies having a triangular shape or the like in cross section, on both of the plate surface of the blade part and the front end face of the supporting plate, the following problem arises.

Specifically, in this kind of the cleaning blade, a stress tends to concentrate on a front end edge of the reinforcing elastic body, which has a cross section that locally changes in shape a great deal. Accordingly, when the blade part comes into sliding contact with the counterpart member, the blade part is easily bent at a position of the front end edge of the reinforcing elastic body, so that a contact angle between the surface of the counterpart member and the blade part tends to be small. In fact, according to this cleaning blade, the followability to the surface of the counterpart member lowers unintentionally by increasing the contact pressure without any consideration, so that slip-through of a toner generates in a long time use.

In consideration of such a background as described above, the present disclosure provides a cleaning blade that is capable of preventing or reducing slip-through of a toner in a long time use by increasing a contact pressure without changing the position of the cleaning blade to be closer to the a counterpart member, and also by ensuring sufficient followability to the surface of the counterpart member.

One aspect of the present disclosure provides a cleaning blade to be used to remove residual toner remaining on a surface of a counterpart member in an electrophotographic image forming device by sliding contact with the counterpart member. The cleaning blade includes a support including a plate-shaped portion; and a blade part that is made of polyurethane and is joined to the plate-shaped portion in integral forming. The blade part includes a plate-shaped blade body portion that is joined to a plate surface of the plate-shaped portion, and a reinforcing portion that is formed integrally with the blade body portion, extends from a surface of the blade body portion, and is joined to a front end face of the plate-shaped portion. The reinforcing portion has a curved surface that curves inward of the reinforcing portion.

The above described cleaning blade has the blade part that is joined to the plate-shaped portion of the support in integral forming. Because the blade part has the reinforcing portion in addition to the blade body portion, the thickness (cross sectional area) of the blade part increases on the base end side so as to enhance the rigidity of the blade part. Thus, according to this cleaning blade, the contact pressure of the blade part can be increased without changing the position of the cleaning blade to be closer to the counterpart member.

Furthermore, the reinforcing portion extends from the surface of the blade body portion, and is formed integrally with the blade body portion. In addition, the reinforcing portion has, on the outer surface, a curved surface that curves inward, and thus the curved surface smoothly shifts to the surface of the blade body portion at the front end edge of the reinforcing portion. The reinforcing portion can disperse a stress in a whole body, so that the stress is less likely concentrated on the front end edge of the reinforcing portion. Consequently, the blade body portion is hardly bent at a position of the front end edge of the reinforcing portion in sliding contact with the counterpart member, so that the contact angle can be easily maintained to be large. In this way, the cleaning blade can secure sufficient followability to the surface of the counterpart member.

As mentioned above, the cleaning blade can prevent or reduce the slip-through of a toner in a long time use by increasing the contact pressure without changing the position of the cleaning blade to be closer to the counterpart member, and also by securing sufficient followability to the surface of the counterpart member.

### BRIEF DESCRIPTION OF DRAWINGS

FIG. 1 is an explanatory view schematically illustrating a use state of a cleaning blade according to Embodiment 1.

FIG. 2 is a side view schematically illustrating the cleaning blade according to Embodiment 1.

FIG. 3 is an elevation view schematically illustrating the cleaning blade according to Embodiment 1.

FIG. 4 is a schematic cross-section view for illustrating a detailed configuration of a blade part.

FIG. 5 is an explanatory view illustrating a cleaning blade according to one example having a blade body portion thickened in the central portion in the longitudinal direction.

FIG. 6 is an explanatory view illustrating a cleaning blade according to one example having a blade body portion thinned in the central portion in the longitudinal direction.

FIG. 7 is a side view schematically illustrating a cleaning blade of Embodiment 2.

FIG. 8 is a side view schematically illustrating a cleaning blade according to Embodiment 3.

FIG. 9 is a side view schematically illustrating a cleaning blade according to Embodiment 4.

FIGS. 10A, 10B and 10C are explanatory views for illustrating configurations of cleaning blades in Experimental Example. FIG. 10A shows Sample 13; FIG. 10B shows Sample 14; and FIG. 10C shows Sample 15.

### MODE FOR CARRYING OUT THE INVENTION

The above described cleaning blade is used to remove residual toner that remains on the surface of a counterpart member in an electrophotographic image forming device, by sliding contact with the counterpart member. Specific examples of the image forming device may include image forming devices that employ an electrophotographic system using a charged image, such as copying machines, printers, facsimile machines, multifunction machines and on-demanded printers. Examples of the counterpart member may include image bearing members such as a photoreceptor drum and an intermediate transfer belt. Herein, the intermediate transfer belt is used for transfer of a toner image in the following way. The toner image carried on the image bearing member is primarily transferred onto the intermediate transfer belt, and then the toner image is secondarily transferred from the intermediate transfer belt onto a transfer material such as paper. More specifically, the cleaning blade can be used in the following way. The edge portion of the front end of the blade part serves as a sliding contact portion for sliding contact with the counterpart member. The cleaning blade scrapes off and removes the residual toner that remains on the surface of the counterpart member and has been carried to the sliding contact portion by bringing the sliding contact portion into sliding contact with the surface of the counterpart member under operation.

The cleaning blade includes a support having a plate-shaped portion. The support can be formed from various metal materials or the like. The plate-shaped portion can be formed, for instance, in a rectangular shape having a predetermined thickness, and can be joined to the blade part at the front end side in a transverse direction. In this case, the plate-shaped portion can preferably have, in a longitudinal direction, a length set at 120 to 400 mm, and more preferably at 230 to 360 mm; and have, in a transverse direction, a length set at 5 to 50 nm, and more preferably at 9 to 30 mm. In addition, the plate-shaped portion can preferably have a thickness set at 1 to 2.6 mm, and more preferably at 1.2 to 2 mm. More specifically, the support can be configured, for instance, to have an attaching portion that is connected to the plate-shaped portion and is attached to a member of the image forming device. In this case, the support may be formed to have an “L” shape in cross section.

The cleaning blade includes a blade part made of polyurethane, which is joined to the plate-shaped portion in integral forming. The language, “joined to the plate-shaped portion in integral forming” represents that the blade part is joined to the plate-shaped portion along with curing of a polyurethane material when the blade part is formed. Herein, a primer layer may be formed on the surface of the plate-shaped portion. The blade part can be specifically made of polyurethane rubber, a polyurethane elastomer and the like, which are advantageous in view of flexibility, toughness, and enhancement of the followability, for instance.

The blade part includes a plate-shaped blade body portion and a reinforcing portion. The blade body portion of the blade part is joined to the plate surface of the plate-shaped portion in the support. Specifically, the blade body portion can be joined at the base end side to the plate surface of the plate-shaped portion on the counterpart member side. Herein, the free length of the joined blade body portion can be preferably set at 5 to 20 mm, more preferably at 6 to 12 mm, and further preferably at 7 to 10 mm. In addition, the thickness of the blade body portion can be preferably set at 1 to 2.2 mm, and more preferably at 1.5 to 2 mm. Herein, the free length of the blade body portion is a distance between the front end face of the plate-shaped portion and the front end face of the blade body portion. The thickness of the blade body portion can be made uniform in the longitudinal direction, can be thinned only in the central portion, or can be thickened only in the central portion. In any case, the thickness is defined as a value that was measured at the central portion in the longitudinal direction at a position of the front end face of the blade part.

The reinforcing portion of the blade part extends from the surface of the blade body portion, and is joined to the front end face of the plate-shaped portion. The reinforcing portion can be specifically configured to extend from the plate surface of the blade body portion on the side opposite to the counterpart member side. The reinforcing portion has a curved surface that curves inward of the reinforcing portion. Here, when viewed in a cross section perpendicular to the longitudinal direction of the blade part, a curbed line that represents the curved surface and a plate face line that represents a plate face of the blade body portion intersect at a point defined as X, and the curved line that represents the curved surface and a front end line that represents the front end face of the plate-shaped portion intersect at a point defined as Y. The curved line is positioned below (inside) a straight line XY that connects the point X and the point Y. Herein, the point X corresponds to the position of the front end edge of the curved portion. The point Y corresponds to the position of the upper end edge of the curved portion.

The width of the reinforcing portion can be specifically set in a range of 0.5 to 8 mm, for instance. According to such a configuration, the contact pressure can be easily increased and the followability can be surely enhanced, so that a cleaning blade that can easily prevent or reduce slip-through of a toner in a long time use can be obtained. In addition, as one of the other advantages, a joining strength can be easily enhanced by increase of a joint area between the reinforcing portion and the support. The width of the reinforcing portion can be preferably set at 2 mm or more, more preferably at 3 mm or more, and further preferably at 3.5 mm or more, from the viewpoint for increase of the contact pressure, prevention of curling up, and the like. In addition, the width of the reinforcing portion can be preferably set at 7 mm or less, more preferably at 6 mm or less, and further preferably at 5 mm or less, from the viewpoint for enhancement of the followability, and the like. Herein, the width of the reinforcing portion is defined as a distance between the front end face of the plate-shaped portion and the front end edge of the reinforcing portion.

The height of the reinforcing portion can be specifically set in a range of 0.5 to 5 mm, for instance. According to such a configuration, the contact pressure can be easily increased and the followability can be surely enhanced, so that a cleaning blade that can easily prevent or reduce the slip-through of a toner in a long time use can be obtained. In addition, as one of the other advantages, a joining strength can be easily enhanced by increase of a joint area between the reinforcing portion and the support. The height of the reinforcing portion can be preferably set at 0.7 mm or more, more preferably at 0.8 mm or more, and further preferably at 0.9 mm or more, from the viewpoint for increase of the contact pressure, prevention of curling up, and the like. In addition, the height of the reinforcing portion can be preferably set at 4 mm or less, more preferably at 3 mm or less, and further preferably at 2 mm or less, from the viewpoint for enhancement of the followability, and the like. Herein, the height of the reinforcing portion is defined as a distance between a plate face of the blade body portion on the side opposite to the counterpart member side and an upper end edge at which the curved surface of the reinforcing portion intersects (contacts?) with the front end face of the plate-shaped portion.

In the cleaning blade, the thickness of the blade body portion can be set in a range of 0.7 to 3 mm at the front end thereof. According to such a configuration, the contact pressure can be easily increased and the followability can be surely enhanced, so that a cleaning blade that can easily prevent or reduce the slip-through of a toner in a long time use can be obtained. In addition, as one of the other advantages, the joining strength with the support can be easily enhanced. The thickness of the blade body portion at the front end can be preferably set at 1 mm or more, more preferably at 1.3 mm or more, further preferably at 1.5 mm or more, and particularly preferably at 1.8 mm or more, from the viewpoint for increase of the contact pressure, prevention of curling up, and the like. In addition, the thickness of the blade body portion at the front end can be preferably set at 2.2 mm or less, more preferably at 2.1 mm or less, and further preferably at 2 mm or less, from the viewpoint for surely achieving enhancement of the followability with ease.

The reinforcing portion, specifically, can be formed, for instance, by use of a molding die for integral molding of the blade part, or by polishing and the like.

In the cleaning blade, the blade body portion can be subjected to a surface treatment so as to have a friction coefficient lower than that in the inside of the blade body portion, or to be provided with a film formed on the surface thereof. According to such a cleaning blade, the friction on the surface of the blade body portion can be reduced so as to easily prevent or reduce the curling up of the blade body portion and slip-through of a toner due to the friction. Thus, a synergistic effect of the blade part formed in integral forming and presence of the reinforcing portion achieves a cleaning blade that can easily prevent or reduce the slip-through of a toner. Herein, the inside of the blade body portion corresponds to a portion which is inner than a surface layer subjected to a surface treatment and has not been subjected to the surface treatment.

The surface treatment is only required to reduce a dynamic friction coefficient of the blade body portion on its surface compared to that in the inside of the blade body portion. One specific example of the surface treatment may include, for instance, a method of forming a cured layer on a surface layer of the blade body portion by impregnating the blade body portion with an ultraviolet curing resin, and then subjecting the blade body portion to ultraviolet irradiation treatment to cure the ultraviolet curing resin. Other examples of the surface treatment may include, for instance, a method of forming a cured layer on a surface portion of the blade body portion by impregnating the blade body portion with a surface treatment liquid that contains an isocyanate compound, and subjecting the blade body portion to heat treatment to thereby form the cured layer on the surface layer of the blade body portion. Meanwhile, the film may be formed on the surface of the blade body portion, specifically, by chemical vapor deposition with use of a hydrocarbon gas converted into a plasma state by a microwave, or by a plasma CVD method to form a diamond-like carbon film, and the like.

In the a cleaning blade, the dynamic friction coefficient of the surface of the blade body portion can be specifically set preferably, for instance, at 3.0 or less, more preferably at 1.0 or less, and further preferably at 0.5 or less. Herein, the dynamic friction coefficient is measured in the following way. The edge portion of the blade body portion is pressed onto a metal plate member having a PET sheet with a thickness of 150 μm on the surface, at an abutting angle θ: 25°, and at a contact pressure: 1 N/cm. Subsequently, the plate member is moved to a side where the contact angle is formed, at a speed of 2.5 mm/second, and the dynamic friction coefficient is measured.

In the cleaning blade, the blade body portion can contain an electroconductive agent. In such a cleaning blade, the blade body portion is made electroconductive, and enables to eliminate an electric charge of the toner at the time of cleaning. Consequently, the toner in the counterpart member such as the image bearing member can be easily taken out. A cleaning blade that is advantageous for enhancing cleanability can be achieved.

Specific examples of the electroconductive agent may include an ion conductive agent or an electron conductive agent. As for the ion conductive agent, a liquid ion conductive agent and a solid ion conductive agent are known. An ion conductive agent that is solid at ordinary temperature may be preferably used. This is because such agent is less likely to cause bleeding and contaminating of the counterpart member such as the image bearing member. Specific examples of the ion conductive agent may specifically include, for instance, quaternary ammonium salts, alkali metal salts and alkali earth metal salts. More specifically, a potassium salt and the like can be preferably employed as the ion conductive agent. The potassium salt may include, for instance, at least one anion selected from the group consisting of CF₃SO₂C₄F₉SO₂N⁻, (CF₃SO₂)₂N⁻, (FSO₂)₂N⁻, C₂₈H₂₀BO₆⁻, AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₃C⁻, AsF₆⁻, SbF₆⁻, F(HF)N⁻, CF₃CF₂CF₂CF₂SO₃⁻, (CF₃CF₂SO₂)₂N⁻, CF₃CF₂CF₂COO⁻, (C₄FSO₂)₂N⁻, CF₂ (CF₂SO₂)₂N⁻ and CF₃SO₂NH₂⁻. In addition, examples of the electron conductive agent may include, for instance, carbon black, and fine particles of a metal oxide.

In the cleaning blade, the blade body portion can contain fine particles and have protrusions formed by the fine particles on the surface. According to such a cleaning blade, the slip-through of a toner can be prevented or reduced, and also the contact area between the surface of the counterpart member and the blade body portion can be reduced. Therefore, the frictional force acting between the counterpart member and the blade body portion can be reduced with ease, which is advantageous for reducing the friction. In addition, this can also contribute to enhancement of abrasion resistance of the blade body portion. Herein, a part of the above described fine particles is permitted to be exposed on the surface of the blade body portion.

As for the fine particles, nano-size particles each having a size of 1 μm or less can be preferably employed. Specifically, the fine particles may have a mean particle size of, for instance, 1 to 900 nm, preferably 5 to 700 nm, and more preferably 10 to 500 nm. Herein, the mean particle size is obtained as a mean value of the particle sizes of 10 fine particles selected in descending order of the size as a result of the observation on the cross section of the blade body portion with a scanning electron microscope. The material of the fine particles may be an inorganic material or an organic material. Specific examples of the fine particle may include, for instance, silica particles, alumna particles and metal particles. Examples of the metal that constitutes the metal particle may include Au, Ag, Ni, Mn and an alloy of the metals. Such metals can be used singly or in combinations of two or more.

In the cleaning blade, the plate-shaped blade body portion may be joined to the plate face of the plate-shaped portion substantially in parallel to the plate face, or may be joined to the plate face of the plate-shaped portion in an inclined manner with respect to the plate face. In the cleaning blade, because the blade part is joined to the plate-shaped portion in integral forming and has the reinforcing portion, the angle of the blade part with respect to the plate face of the plate-shaped portion can be finely adjusted as in the above described ways with ease. Consequently, in the cleaning blade, the contact angle can be easily adjusted depending on a target model of the image forming device, and flexibility of attachment of the cleaning blade can be enhanced, accordingly.

In addition, the cleaning blade has high joinability because the blade part is joined to the plate-shaped portion in integral forming and has the reinforcing portion. Thus, the cleaning blade has an advantage to design the blade body portion so as to have thin thickness. The plate face of the blade body portion on the side opposite to the counterpart member side can be arranged in the same plane as a plane imaginarily extended from the plate face of the plate-shaped portion on the counterpart member side. In addition to this arrangement, the plate face of the blade body portion on the side opposite to the counterpart member side can be arranged between the plane imaginarily extended from the plate face of the plate-shaped portion on the counterpart member side and the plane imaginarily extended from the plate face of the plate-shaped portion on the side opposite to the counterpart member side. The latter arrangement is advantageous for designing the blade body portion to have thin thickness.

In addition, because the cleaning blade has the blade part that is integrally formed, the thickness of the blade body portion can be finely controlled. For instance, the thickness of the blade body portion may be fixed in the longitudinal direction of the blade body portion, may be thicker in the central portion in the longitudinal direction than in both ends, and may be thinner in the central portion in the longitudinal direction than in both ends.

Herein, the configurations described above can be combined in order to exert the corresponding effects described above, and the like, as needed.

### EMBODIMENTS

Hereinafter, the cleaning blades according to embodiments of the present disclosure will be described with reference to the drawings.

### Embodiment 1

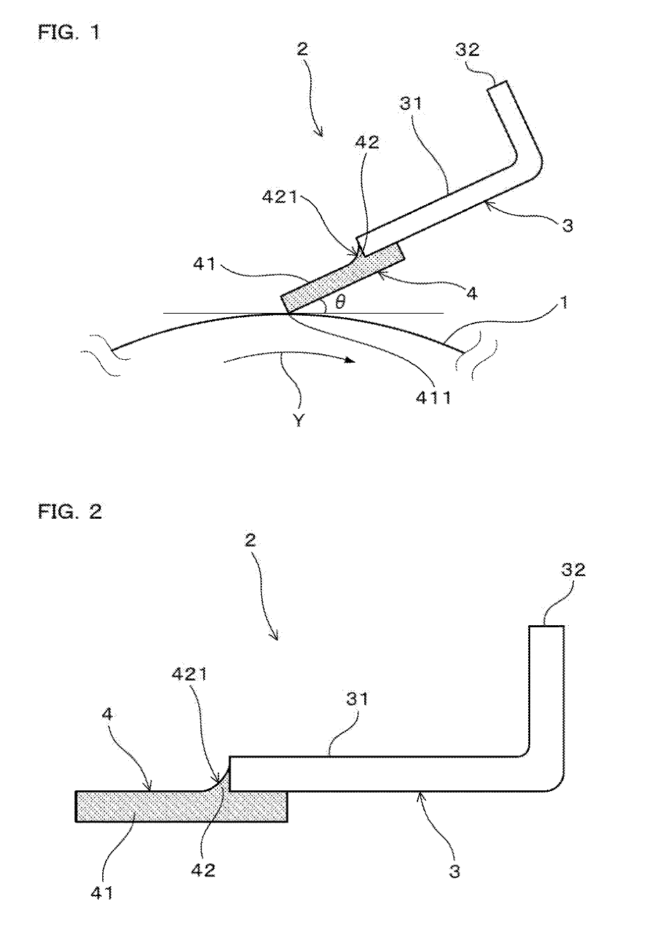

A cleaning blade according to Embodiment 1 will be described with reference to FIGS. 1 to 6. As illustrated in FIG. 1, a cleaning blade 2 of the present embodiment is used to remove residual toner (not shown) remaining on a surface of a counterpart member 1 in an electrophotographic image forming device by sliding contact with the counterpart member 1. In the present embodiment, the counterpart member 1 is a photoreceptor drum as an image bearing member. In the cleaning blade 2, a front edge portion 411 on the front end of the blade part 4 serves as a sliding contact portion to be brought in sliding contact with the counterpart member. In FIG. 1, θ represents an abutting angle, and an arrow Y shows a rotation direction of the photoreceptor drum as the image bearing member.

As shown in FIGS. 2 to 4, the cleaning blade 2 of the present embodiment includes a support 3 including a plate-shaped portion 31 and a blade part 4 made of polyurethane. The blade part 4 is joined to the plate-shaped portion 31 in integral forming. In this embodiment, the support 3 further includes an attaching portion 32 that is continuous to the plate-shaped portion 31. The attaching portion 32 is a portion through which the support 3 is attached to a cartridge of the image forming device. The support 3 is made of metal and is formed in a long shape. The plate-shaped portion 31 and the attaching portion 32 are formed in rectangular shape with a certain thickness. The attaching portion 32 protrudes from the base end part of the plate-shaped portion 31 in the direction perpendicular to the plate face of the plate-shaped portion 31. Thus, the support 3 in the present embodiment is formed to have an “L” shape in cross section. The plate-shaped portion 31 has 354 mm length in the longitudinal direction, 15 mm length in the lateral direction, and 2 mm thickness.

A blade part 4 includes a plate-shaped blade body portion 41 and a reinforcing portion 42. The plate-shaped blade body portion 41 is joined to a plate surface of the plate-shaped portion 31. In this embodiment, the blade body portion 41 is joined to the plate surface of the plate-shaped portion 31 substantially in parallel. The plate face of the blade body portion 41 on the side opposite to the side of the counterpart member 1 is arranged in the substantially same plane as a plane imaginarily extended from the plate surface of the plate-shaped portion 31 on the side of the counterpart member 1. In the blade body portion 41, the portion of the base end side is joined to the plate surface of the plate-shaped portion 31 on the side of counterpart member 1. The reinforcing portion 42 extends from the surface of the blade body portion 41 and is joined to a front end face of the plate-shaped portion 31. In this embodiment, the reinforcing portion 42 extends from the plate surface of the blade body portion 41 on the side opposite to the counterpart member 1.

Here, the reinforcing portion 42 has a curved surface 421 that curves inward of the reinforcing portion 42. Thus, as shown in FIG. 4, in the reinforcing portion 42 viewed in a cross section perpendicular to the longitudinal direction of the blade part 4, the curved line 421a that represents the curved surface 421, is positioned below (inside) a straight line XY that connects a point defined as X and a point defined as Y. Herein, the point X corresponds to the position of the front end edge of the curved portion 42, and is the point of intersection of the curved line 421a that represents the curved surface 421 and a plate surface line 41a that represents the plate surface of the blade body portion 41. The point Y is the point of intersection of the curved line 421a that represents the curved surface 421 and a front end line 31a that represents the front end face of the plate-shaped portion 31. In other words, the reinforcing portion 42 has an R-shape in which the curved line 421a is convex downward.

In this embodiment, the width W of the reinforcing portion 42 in FIG. 4, is set in a range of 0.5 to 8 mm. The height H of the reinforcing portion 42 is set in a range of 0.5 to 5 mm. The thickness t of the blade body portion 41 at the front end is set in a range of 0.7 to 3 mm. The free length L of the blade body portion 41 is in a range of 5 to 20 mm. The joint length BWL of the joint portion where the blade body portion 41 and the plate-shaped portion 31 of the support 3 are joined each other, is set in a range of 1.5 to 7 mm.

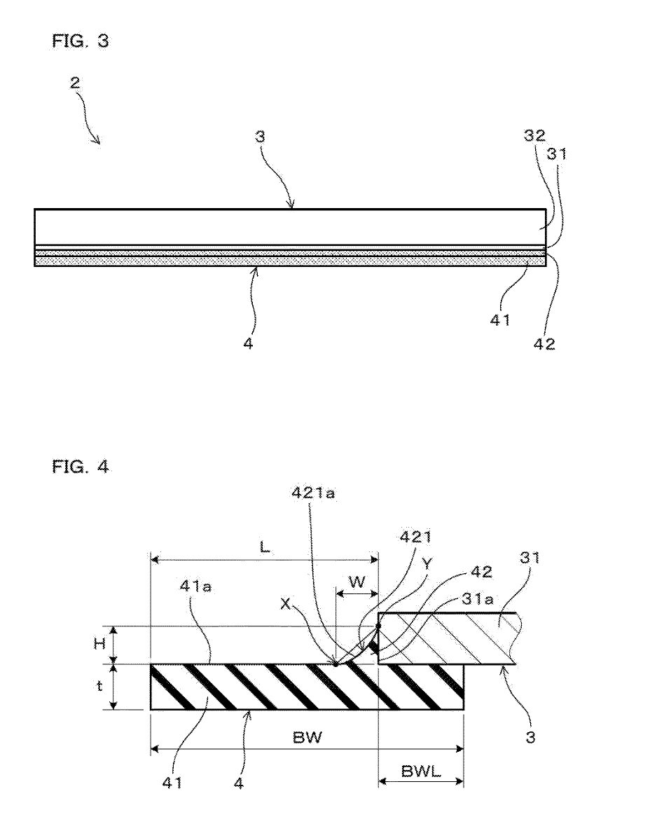

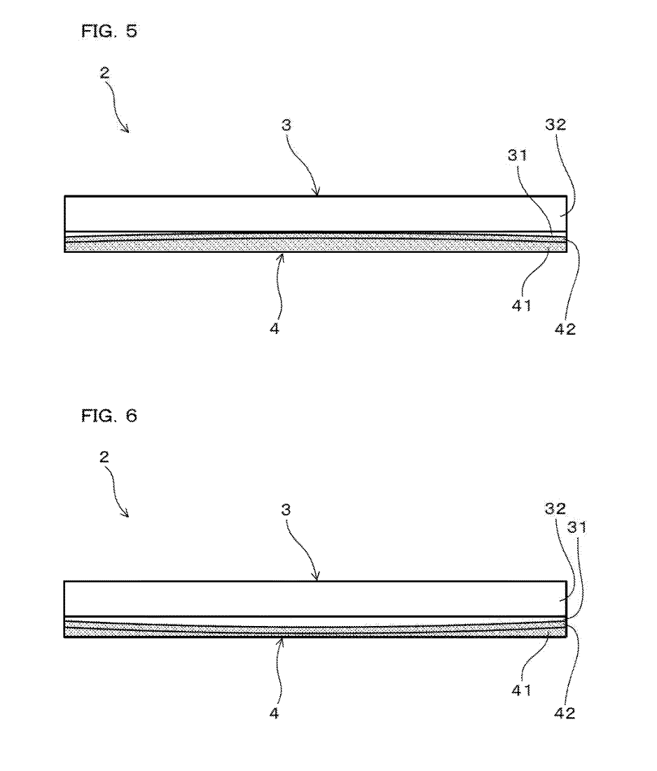

In this embodiment, as shown in FIG. 3, the thickness of the blade body portion 41 is fixed in the longitudinal direction of the blade body portion 41. As shown in FIG. 5, the thickness may be thicker in the central portion in the longitudinal direction than in both ends, and as shown in FIG. 6, the thickness may be thinner in the central portion in the longitudinal direction than in both ends.

### Embodiment 2

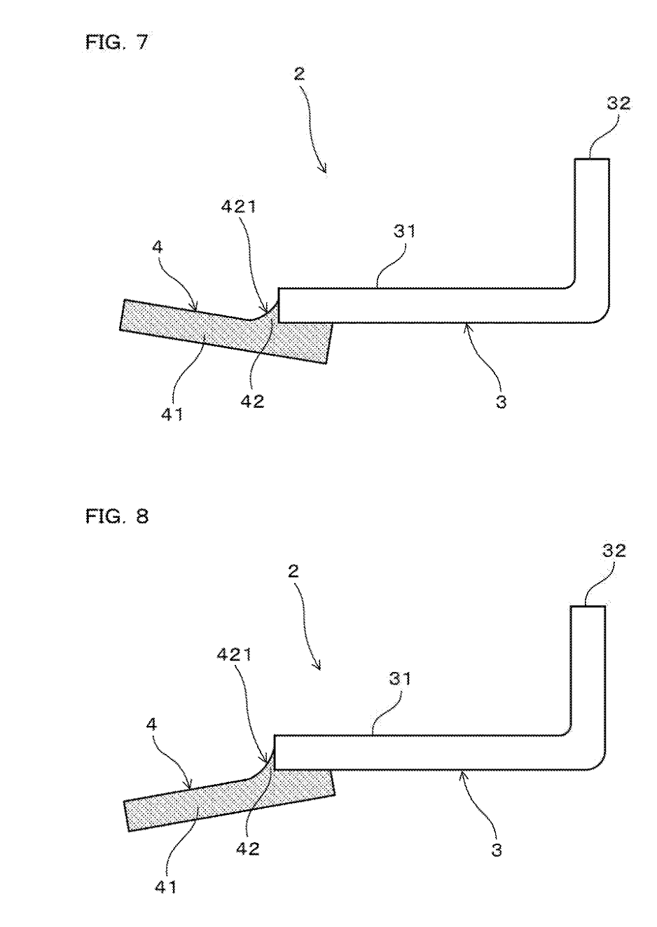

A cleaning blade according to Embodiment 2 will be described with reference to FIG. 7. As illustrated in FIG. 7, the cleaning blade 2 of the present embodiment has the blade body portion 41 that is joined to the plate surface of the plate-shaped portion 31 in an inclined manner with respect to the plate surface. The inclination is set in such a direction that the front end of the blade body portion 41 is apart from the counter member 1. The cleaning blade 2 in Embodiment 2 is one example applied to other model different from the electrophotographic image forming device employed in Embodiment 1. Other configurations are the same as those in Embodiment 1.

### Embodiment 3

A cleaning blade according to Embodiment 3 will be described with reference to FIG. 8. As illustrated in FIG. 8, the cleaning blade 2 of the present embodiment has the blade body portion 41 that is joined to the plate surface of the plate-shaped portion 31 in an inclined manner with respect to the plate surface. The inclination is set in such a direction that the front end of the blade body portion 41 approaches the counter member 1. The cleaning blade 2 of the present embodiment is one example applied to other model different from the electrophotographic image forming devices employed in Embodiments 1 and 2. Other configurations are the same as those in Embodiment 1.

### Embodiment 4

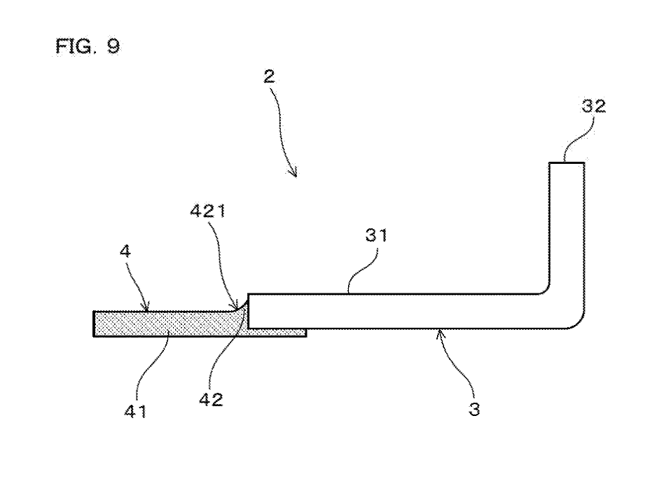

A cleaning blade according to Embodiment 4 will be described with reference to FIG. 9. As illustrated in FIG. 9, in the cleaning blade 2 of the present embodiment, the plate face of the blade body portion 41 on the side opposite to the side of the counterpart member 1 is arranged between a plane imaginarily extended from the plate face of the plate-shaped portion 31 on the side of counterpart member 1 and a plane imaginarily extended from the plate face of the plate-shaped portion 31 on the side opposite to the side of the counterpart member 1. The cleaning blade 2 of the present embodiment is one example in which the thickness of the blade body portion 41 is made thinner than that of the blade body portion in Embodiment 1. Other configurations are the same as in Embodiment 1.

### Experimental Example

Hereinafter, the present disclosure will be described more specifically using an experimental example.

### —Preparation of Urethane Compositions—

Forty four parts by mass of polybutylene adipate (PBA) (“Nippolan 4010” manufactured by Tosoh Corporation) subjected to defoaming in vacuum at 80° C. for 1 hour, and 56 parts by mass of 4,4′-diphenylmethane diisocyanate (MDI) (“Millionate MT” manufactured by Tosoh Corporation) were mixed, and reacted under a nitrogen atmosphere at 80° C. for 3 hours to thereby prepare a main agent solution including a urethane prepolymer.

In addition, 87 parts by mass of the above described polybutylene adipate (PBA), 13 parts by mass of a low molecular weight polyol obtained by mixing 1,4-butanediol (manufactured by Mitsubishi Chemical Corporation) and trimethylolpropane (manufactured by KOEI CHEMICAL COMPANY LIMITED) in a weight ratio of 6:4, and 0.01 parts by mass of triethylenediamine (manufactured by Tosoh Corporation) as a catalyst were mixed under a nitrogen atmosphere at 80° C. for 1 hour to thereby prepare a curing agent solution.

The main agent solution and the curing agent solution both prepared as described above, were mixed under a vacuum atmosphere at 60° C. for 3 minutes at a mixing ratio of 94 parts by mass of the curing agent solution to 100 parts by mass of the main agent solution to be sufficiently defoamed. Thus, a urethane rubber composition (1) was prepared. The urethane rubber composition (1) was used to prepare Samples 1 through 10, and 13 through 15 of the cleaning blades.

A urethane rubber composition (2) was prepared in the same manner as in preparation of the urethane rubber composition (1) except that 10 parts by mass of silica particles (SICASTAR 43-00-202 manufactured by Corefront Corporation; Average particle size: 200 nm) is added to 100 parts by mass of the main agent solution. The urethane rubber composition (2) was used to prepare Sample 11 of the cleaning blade.

A urethane rubber composition (3) was prepared in the same manner as in preparation of the urethane rubber composition (1) except that 10 parts by mass of an ion conductive agent (EF-12 manufactured by Mitsubishi Materials Electronic Chemicals Co., Ltd.) is added to 100 parts by mass of the main agent solution. The urethane rubber composition (3) was used to prepare Sample 12 of the cleaning blade.

### —Preparation of Samples 1 Through 12 of the Cleaning Blades—

As shown in FIG. 2, a support composed of a long metal plate that is bent and formed in L-shape in cross section was prepared. For each sample, a mold with a cavity that enables to form the blade part as shown in FIG. 4 was prepared. Here, each of the molds has the cavity for forming the blade part in which the length of the blade body portion is 354 mm, the width BM of the blade body portion is 13 mm, the free length L of the blade body portion is 8.6 mm, and the thickness of the blade body portion is 2 mm, the width of the reinforcing portion shown in Table 1 is W mm, the height of the reinforcing portion is H mm and the thickness of the front end of the blade body portion is t mm.

Subsequently, each urethane composition was injected into the cavity of the corresponding mold in which the support was placed, and heated at 130° C. for 10 minutes to be cured. The cured resultant was taken out from the mold to prepare each of Samples 1 through 9, 11 and 12 cleaning blades. In preparation of Sample 10 of the cleaning blade, the surface of the blade part as formed was treated with a surface treatment liquid to thereby form a cured layer. The surface treatment liquid is isocyanate-based one, and specifically contains a polyisocyanate, a polymerization catalyst, and an organic solvent. The surface treatment was performed by immersing the blade part in the surface treatment liquid for 30 minutes, taking out the blade part from the liquid and heating the blade part at 120° C.

### —Preparation of Sample 13 of a Cleaning Blade—

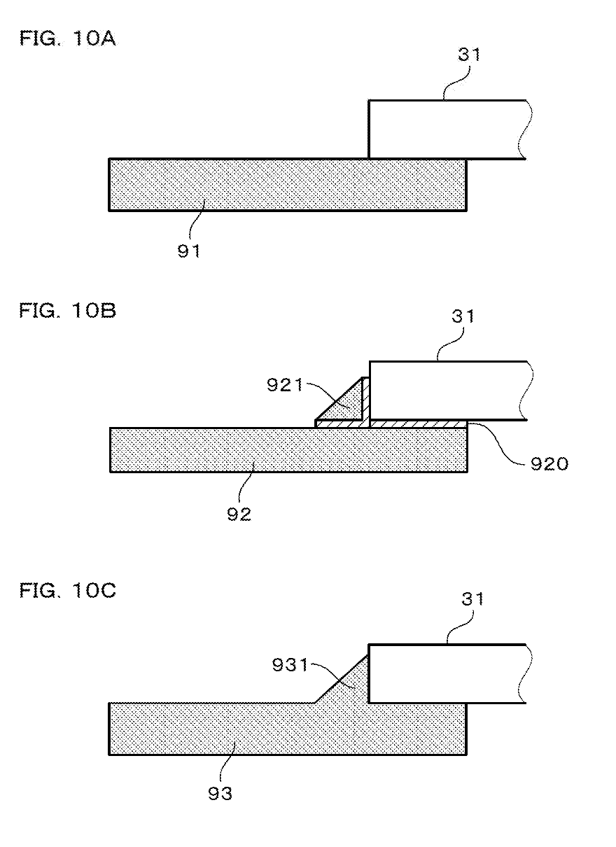

Sample 13 cleaning blade was prepared in the same manner as in the preparation of Sample 1 cleaning blade except that no reinforcing portion was formed in the blade part as shown in FIG. 10A so that the blade body portion 91 with no reinforcing portion was formed as a blade part.

### —Preparation of Sample 14 of a Cleaning Blade—

A blade part having 354 mm length and 13 mm width was obtained from a polyurethane rubber sheet with 2 mm thickness which was formed from the urethane composition (1). Further, a reinforcing-portion forming material with a dimension as shown in Table 1 was formed from the urethane composition (1) to have a right-angled triangular shape in cross section. Subsequently, as shown in FIG. 10B, the blade part 92 was joined to the plate-shaped portion 31 of the support 3, which was prepared in Sample 1, with a primer and a hot melt adhesive 920. Further, the reinforcing-portion forming material 921 was joined to both of the plate face of the blade part 92 and the front end face of the plate-shaped portion 31 with the primer and the hot melt adhesive 920 to form the reinforcing portion. Thus, Sample 14 cleaning blade was prepared.

### —Preparation of Sample 15 of a Cleaning Blade—

Sample 15 cleaning blade was prepared as shown in FIG. 10C, in the same manner as in the preparation of Sample 1 cleaning blade except that the blade part was formed to have the blade body portion 93 and the reinforcing portion 931 having a right-angled triangular shape in cross section but no curved surface, with a dimension shown in Table 1.

### —Evaluation of Slip-Through of a Toner in a Durability Test—

Each cleaning blades was mounted on a photoreceptor drum of a digital copier (“imagio MPC4000” manufactured by Ricoh Company Ltd.) in a sliding contact manner, and 100,000 sheets of a character chart image (A4 size) having an image area ratio of 5% were continuously output under an environment of 23° C.×55% RH. After the 100,000 sheets were output, white images, solid black images and halftone images were output, and the images were evaluated. In addition, after the 100,000 sheets were output, slip-through of a toner on the photoreceptor drum was visually checked. The case where no image streak was observed in the image evaluation, and no linear streak was found on the photoreceptor drum by the visual check was ranked as “A”, assuming that slip-through of a toner could be prevented after a long time use. The case where the image streak was observed was ranked as “C”, assuming that slip-through of a toner could not be prevented or reduced after a long time use. The case where the image streak was observed in the image evaluation and a linear streak was found on the photoreceptor drum by the visual check was ranked as “C⁻”, assuming that slip-through of a toner would remarkably generate after a long-term use.

Table 1 shows the specifications of the sample cleaning blades as prepared and the evaluation results.

TABLE 1

| | Samples Nos. | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Blade part | | | | | | | | | | | | | | | |
| Integral forming | ◯ | ◯ | ◯ | ◯ | ◯ | ◯ | ◯ | ◯ | ◯ | ◯ | ◯ | ◯ | ◯ | — | ◯ |
| Adhesion with adhesive agent | — | — | — | — | — | — | — | — | — | — | — | — | — | ◯ | — |
| Blade body portion | | | | | | | | | | | | | | | |
| Thickness t of front end (mm) | 2 | 2 | 2 | 2 | 2 | 2 | 2 | 2 | 2 | 2 | 2 | 2 | 2 | 2 | 2 |
| Surface treatment for friction reduction | Not | Not | Not | Not | Not | Not | Not | Not | Not | Done | Not | Not | Not | Not | Not |
| | done | done | done | done | done | done | done | done | done | | done | done | done | done | done |
| Addition of fine particles | Not | Not | Not | Not | Not | Not | Not | Not | Not | Not | Done | Not | Not | Not | Not |
| | done | done | done | done | done | done | done | done | done | done | | done | done | done | done |
| Addition of electroconductive agent | Not | Not | Not | Not | Not | Not | Not | Not | Not | Not | Not | Done | Not | Not | Not |
| | done | done | done | done | done | done | done | done | done | done | done | | done | done | done |
| Reinforcing portion | | | | | | | | | | | | | | | |
| Surface profile: | | | | | | | | | | | | | | | |
| Inwardly curved surface [R] | R | R | R | R | R | R | R | R | R | R | R | R | None | Δ | Δ |
| Flat surface[Δ] | | | | | | | | | | | | | | | |
| Width of reinforcing portion W (mm) | 1 | 4 | 7 | 1.5 | 4 | 7 | 2 | 4 | 7 | 7 | 7 | 7 | | 7 | 7 |
| Height of reinforcing portion H (mm) | 1 | 1 | 1 | 1.5 | 1.5 | 1.5 | 2 | 2 | 2 | 2 | 2 | 2 | | 2 | 2 |
| Evaluation of slip-through of toner | A | A | A | A | A | A | A | A | A | A | A | A | C⁻ | C | C |
| in durability test | | | | | | | | | | | | | | | |

Table 1 makes certain the followings.

Each of the cleaning blade samples, Samples 1 through 12 has the blade part that is joined to the plate-shaped portion of the support in integral forming. Further, the blade part has the reinforcing portion in addition to the blade body portion. In such a cleaning blade, the thickness (cross sectional area) of the blade part increases on the base end side so as to enhance the rigidity of the blade part. Thus, according to such cleaning blades, the contact pressure of the blade part can be increased without changing the position of the cleaning blade to be closer to the photoreceptor drum as a counterpart member.

Furthermore, the reinforcing portion extends from the surface of the blade body portion, and is formed integrally with the blade body portion. In addition, the reinforcing portion has, on the outer surface, a curved surface that curves inward. The curved surface smoothly shifts to the surface of the blade body portion at the front end edge of the reinforcing portion. Thus, the reinforcing portion can disperse a stress in a whole body, so that the stress is less likely concentrated on the front end edge of the reinforcing portion. Consequently, the blade body portion is hardly bent at a position of the front end edge of the reinforcing portion in sliding contact with the counterpart member, so that the contact angle can be easily maintained to be large. Thus, the cleaning blade can secure sufficient followability to the surface of the photoreceptor drum as a counterpart member.

The above description makes it appear that the cleaning blade enables to prevent or reduce the slip-through of a toner in a long time use by increasing the contact pressure without changing the position of the cleaning blade to be closer to the counterpart member, and also by securing sufficient followability to the surface of the counterpart member.

In the cases of employing Samples 10 through 12 cleaning blades, the soil on the photoreceptor drum was less in comparison with the cases employing Samples 1 through 9 cleaning blade. Such effect was brought about for the reasons described below. The surface treatment for friction reduction and the addition of the fine particles improve sliding property of the blade body portion. And, the addition of the electroconductive agent improves a static eliminating performance for the toner in the blade body portion. Consequently, the cleaning blades enable to maintain the capacity to scrape off the toner from the drum continuously so as to exhibit it over a long time with ease.

Unlike these samples, Sample 13 of a cleaning blade has no reinforcing portion in the blade part. Thus, Sample 13 cleaning blade had no sufficient contact pressure, so that slip-through of a toner generated in the durability test, which resulted in defects of image such as an image streak.

Samples 14 and 15 of cleaning blades each include the reinforcing body portion, however, the reinforcing body portion has no curved surface. Thus, Samples 14 and cleaning blades had low followability to the surface of the photoreceptor drum, so that slip-through of a toner generated in the durability test, which caused defects of an image such as an image streak.

The embodiments according to the present disclosure have been specified above, however, the present disclosure is not limited to these embodiments, and various modifications can be made within the scope that does not impair the effects of the present disclosure.

1. A cleaning blade to be used to remove residual toner remaining on a surface of a counterpart member in an electrophotographic image forming device by sliding contact with the counterpart member, the cleaning blade comprising:
a support including a plate-shaped portion; and
a blade part being made of polyurethane, and being joined to the plate-shaped portion by integral forming, wherein
the blade part includes a plate-shaped blade body portion that is joined to a plate surface of the plate-shaped portion; and a reinforcing portion that is formed integrally with the blade body portion, extends from a surface of the blade body portion, and is joined to a front end face of the plate-shaped portion, and
the reinforcing portion has a curved surface that curves inward of the reinforcing portion.

2. A cleaning blade according to claim 1, wherein the reinforcing portion has a width set in a range of 0.5 to 8 mm.

3. A cleaning blade according to claim 2, wherein the reinforcing portion has a height set in a range of 0.5 to 5 mm.

4. A cleaning blade according to claim 3, wherein the blade body portion has a thickness set in a range of 0.7 to 3 mm at a front end thereof.

5. A cleaning blade according to claim 4, wherein the blade body portion is subjected to a surface treatment so as to have a dynamic friction coefficient lower than that in an inside of the blade body portion, or is provided with a film formed on a surface thereof.

6. A cleaning blade according to claim 5, wherein the blade body portion contains an electroconductive agent.

7. A cleaning blade according to claim 6, wherein the electroconductive agent is a potassium salt.

8. A cleaning blade according to claim 7, wherein the blade body portion contains fine particles and has protrusions formed by the fine particles on the surface of the blade body portion.

9. A cleaning blade according to claim 1, wherein the reinforcing portion has a height set in a range of 0.5 to 5 mm.

10. A cleaning blade according to claim 1, wherein the blade body portion has a thickness set in a range of 0.7 to 3 mm at a front end thereof.

11. A cleaning blade according to claim 1, wherein the blade body portion is subjected to a surface treatment so as to have a dynamic friction coefficient lower than that in an inside of the blade body portion, or is provided with a film formed on a surface thereof.

12. A cleaning blade according to claim 1, wherein the blade body portion contains an electroconductive agent.

13. A cleaning blade according to claim 12, wherein the electroconductive agent is a potassium salt.

14. A cleaning blade according to claim 1, wherein the blade body portion contains fine particles and has protrusions formed by the fine particles on the surface.

15. A cleaning blade according to claim 8, wherein the potassium salt includes at least one anion selected from the group consisting of CF₃SO₂C₄F₉SO₂N⁻, (CF₃SO₂)₂N⁻, (FSO₂)₂N⁻, C₂₈H₂₀BO₆⁻, AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₃C⁻, AsF₆⁻, SbF₆⁻, F(HF)N⁻, CF₃CF₂CF₂CF₂SO₃⁻, (CF₃CF₂SO₂)₂N⁻, CF₃CF₂CF₂COO⁻, (C₄FSO₂)₂N⁻, CF₂ (CF₂SO₂)₂N⁻ and CF₃SO₂NH₂⁻.

16. A cleaning blade according to claim 15, wherein the fine particles have a mean particle size of 10 to 500 nm.

17. A cleaning blade according to claim 16, wherein the fine particles are silica particles.

18. A cleaning blade according to claim 7, wherein the potassium salt includes at least one anion selected from the group consisting of CF₃SO₂C₄F₉SO₂N⁻, (CF₃SO₂)₂N⁻, (FSO₂)₂N⁻, C₂₈H₂₀BO₆⁻, AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₃C⁻, AsF₆⁻, SbF₆⁻, F(HF)N⁻, CF₃CF₂CF₂CF₂SO₃⁻, (CF₃CF₂SO₂)₂N⁻, CF₃CF₂CF₂COO⁻, (C₄FSO₂)₂N⁻, CF₂ (CF₂SO₂)₂N⁻ and CF₃SO₂NH₂⁻.

19. A cleaning blade according to claim 8, wherein the fine particles have a mean particle size of 10 to 500 nm.

20. A cleaning blade according to claim 19, wherein the fine particles are silica particles.
